(19) United States
(12) Patent Application Publication
(10) Pub. No.: US 2007/0046710 A1
(43) Pub. Date: Mar. 1, 2007

(54) System for continuous heating of an ink jet printhead in an ink jet apparatus

(76) Inventors: Lucas David Barkley, Lexington, KY (US); Darrel Lee Henry, Versailles, KY (US); Gregory Scott Woods, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/216,305

(22) Filed: Aug. 31, 2005

(51) Int. Cl. B41J 29/38

(52) U.S. Cl. 347/17

(57) ABSTRACT

In an ink jet apparatus having a printhead carrier for carrying an ink jet printhead configured to receive a serial data steam over a serial data channel, a method for performing printhead heating of the ink jet printhead includes performing pre-swath heating of the ink jet printhead by sending serial pre-swath heat data over the serial data channel to the ink jet printhead during an acceleration of the printhead carrier toward a steady-state velocity; and terminating the serial pre-swath heat data immediately prior to priming the ink jet printhead with print data.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates generally to an ink jet apparatus, and more particularly to a method for performing printhead heating of an ink jet printhead.

2. Description of the Related Art

In prior art, an ink jet printhead includes a plurality of jetting heaters used to eject drops of ink during a printing operation. In one type of printhead, for example, printing data is sent to the printhead in a serial data stream. Attempts have been made to achieve a desired printhead operating temperature before printing (pre-heat) in order to achieve acceptable print quality, but such attempts have resulted in a significant reduction in printhead temperature prior to the beginning of printing. It is then attempted to obtain and maintain the desired printhead temperature during printing operations. One type of printhead heating is performed using a substrate heater. Another type of printhead heating is performed by applying electrical power to the jetting heaters of the printhead that yields a heating amount insufficient for ink ejection, referred to herein as a non-nucleating heating (NNH), but is sufficient to heat the printhead substrate at an acceptable rate to achieve an operating temperature within an acceptable amount of time.

### SUMMARY OF THE INVENTION

The present invention, in one form thereof, is directed to a method for performing printhead heating of the ink jet printhead. In an ink jet apparatus having a printhead carrier for carrying an ink jet printhead configured to receive a serial data steam over a serial data channel, the method for performing printhead heating of the ink jet printhead includes performing pre-swath heating of the ink jet printhead by sending serial pre-swath heat data over the serial data channel to the ink jet printhead during an acceleration of the printhead carrier toward a steady-state velocity; and terminating the serial pre-swath heat data immediately prior to priming the ink jet printhead with print data.

The present invention, in another form thereof, is directed to a method for performing printhead heating of the ink jet printhead. In an ink jet apparatus having a printhead carrier for carrying an ink jet printhead configured to receive a serial data steam over a serial data channel, the method for performing printhead heating of the ink jet printhead includes performing stationary heating of the ink jet printhead by sending serial stationary heat data over the serial data channel to the ink jet printhead prior to beginning an acceleration of the printhead carrier toward a steady-state velocity; performing pre-swath heating of the ink jet printhead by sending serial pre-swath heat data over the serial data channel to the ink jet printhead during the acceleration of the printhead carrier toward a steady-state velocity; terminating the serial pre-swath heat data immediately prior to priming the ink jet printhead with print data; and performing print heating of the ink jet printhead during a printing operation, subsequent to the priming the ink jet printhead with print data.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic depiction of a system embodying the present invention.

FIG. 2 is an exemplary depiction of the ink jet printhead of FIG. 1, with the printhead being projected over a sheet of print media.

FIG. 3 is a block diagram of a portion of a controller, and shows a serial data channel that communicatively couples a hardware module to the inkjet printhead of FIG. 1.

FIG. 4 shows a graph depicting printhead carrier velocity of a printhead carrier carrying a printhead correlated with a graph of the printhead temperature of the printhead.

FIG. 5 is a flowchart of a method for performing printhead heating of an ink jet printhead in accordance with the present invention.

FIG. 6 shows an encoder signal waveform in relation to a general representation of a serial data stream.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software-based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

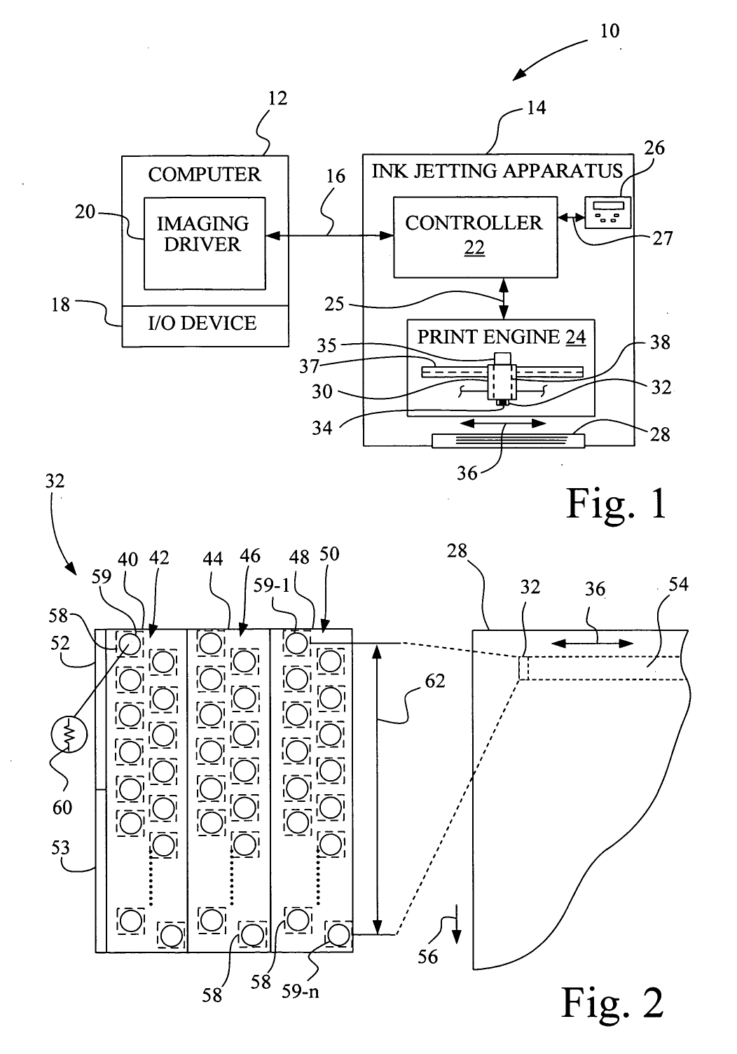

Referring to FIG. 1, there is shown a diagrammatic depiction of an imaging system 10 embodying the present invention. Imaging system 10 may include a computer 12 and an ink jet apparatus 14.

In embodiments that include computer 12, ink jet apparatus 14 may be communicatively coupled to computer 12 via a communications link 16. As used herein, the term “communications link” generally refers to structure that facilitates electronic communication between two components, and may operate using wired or wireless technology. Accordingly, communications links, such as communications link 16, may be, for example, a direct electrical wired connection, a direct wireless connection (e.g., infrared or r.f.), or a network connection (wired or wireless), such as for example, an Ethernet local area network (LAN) or a wireless networking standard, such as IEEE 802.11.

In embodiments including computer 12, computer 12 may be, for example, a personal computer including an input/output (I/O) device 18, such as keyboard and display monitor. Computer 12 further includes a processor, input/output (I/O) interfaces, memory, such as RAM, ROM, NVRAM, and a mass data storage device, such as a hard drive, CD-ROM and/or DVD units. During operation, computer 12 includes in its memory a software program including program instructions that function as an imaging driver 20 (e.g., a printer driver) for ink jet apparatus 14. Imaging driver 20 is in communication with ink jet apparatus 14 via communications link 16. Imaging driver 20, for example, may include a halftoning unit and a data formatter that places print data and print commands in a format that can be recognized by ink jet apparatus 14. In a network environment, communications between computer 12 and ink jet apparatus 14 may be facilitated via a standard communication protocol, such as the Network Printer Alliance Protocol (NPAP).

In the example of FIG. 1, ink jet apparatus 14 also includes a controller 22, a print engine 24 and a user interface 26. Imaging driver 20 of computer 12 is in communication with controller 22 of ink jet apparatus 14 via communications link 16. Imaging driver 20 facilitates communication between ink jet apparatus 14 and computer 12, and may provide formatted print data to ink jet apparatus 14, and more particularly, to print engine 24.

Alternatively, ink jet apparatus 14 may be a standalone unit that is not communicatively linked to a host, such as computer 12. For example, ink jet apparatus 14 may take the form of an all-in-one (AlO), i.e., multifunction, machine that includes standalone copying and facsimile capabilities, in addition to optionally serving as a printer when attached to a host, such as computer 12. Accordingly, all or a portion of imaging driver 20 may be located in controller 22 of inkjet apparatus 14. For example, where inkjet apparatus 14 is a multifunction machine having standalone capabilities, controller 22 of ink jet apparatus 14 may include an imaging driver configured to support a copying function, and/or a fax-print function, and may be further configured to support a printer function.

Controller 22 includes a processor unit, logic circuitry and associated memory, and may be formed as an Application Specific Integrated Circuit (ASIC). Controller 22 communicates with print engine 24 via a communications link 25. Controller 22 communicates with user interface 26 via a communications link 27. Communications links 25 and 27 may be established, for example, by using standard electrical cabling or bus structures, or by wireless connection.

Print engine 24 may be, for example, an ink jet print engine configured for forming an image on a sheet of print media 28, such as a sheet of paper, transparency or fabric.

Print engine 24 may include, for example, a reciprocating printhead carrier 30, and at least one ink jet printhead 32 having one or more of a printhead temperature sensor 34. Associated with printhead 32 is a power supply 35 for supplying electrical signals to printhead 32 for printhead warming, and for ink ejection during printing operations. Power supply 35 is depicted in FIG. 1 as being adjacent to the cartridge associated with printhead 32 for purposes of illustration, and may be located at any convenient location, provided that power supply 35 is communicatively coupled to printhead 32.

Printhead carrier 30 transports ink jet printhead 32 and printhead temperature sensor 34 in a reciprocating manner in a bi-directional main scan direction 36 over an image surface of sheet of print media 28 during printing and/or sensing operations. A position of printhead carrier 30 along bidirectional main scan direction 36 is determined by a position encoder 37. Position encoder 37 may include, for example, an encoder strip having a plurality of spaced openings that are read optically by an encoder strip reader.

Printhead carrier 30 may be mechanically and electrically configured to mount, carry and facilitate one or more printhead cartridges 38, such as a monochrome printhead cartridge and/or one or more color printhead cartridges. Each printhead cartridge 38 may include, for example, an ink reservoir containing a supply of ink, to which at least one respective printhead 32 is attached. In order for print data from computer 12 to be properly printed by print engine 24, the rgb.data generated by computer 12 is converted into data compatible with print engine 24 and printhead(s) 32.

In one system using cyan, magenta, yellow and black inks, printhead carrier 30 may carry four printheads, such as printhead 32, with each printhead carrying an ejector array dedicated to a specific color of ink, e.g., cyan, magenta, yellow and black. As a further example, a single printhead, such as ink jet printhead 32, may include multiple ink jetting arrays, with each array associated with one color of a plurality of colors of ink, and printhead carrier 30 may be configured to carry multiple printheads.

FIG. 2 shows one exemplary configuration of ink jet printhead 32, which includes a cyan nozzle plate 40 corresponding to an ink ejector array 42, a yellow nozzle plate 44 corresponding to an ink ejector array 46, and a magenta nozzle plate 48 corresponding to an ink ejector array 50, for respectively ejecting cyan (C) ink, yellow (Y) ink, and magenta (M) ink.

Printhead 32 may include a printhead memory 52 for storing information relating to printhead 32 and/or ink jet apparatus 14. For example, memory 52 may be formed integral with printhead 32, or may be attached to printhead cartridge 38. In addition, in one embodiment printhead 32 may, optionally, include a substrate heater 53.

As further illustrated in FIG. 2, printhead carrier 30 is controlled by controller 22 to move printhead 32 in a reciprocating manner in bidirectional main scan direction 36, with each left to right, or right to left movement of printhead carrier 30 along bi-directional main scan direction 36 over the sheet of print media 28 being referred to herein as a pass. The area traced by printhead 32 over sheet of print media 28 for a given pass will be referred to herein as a swath, such as for example, swath 54 as shown in FIG. 2. The sheet of print media 28 may be advanced between passes in a media feed direction 56.

In the exemplary ink ejector configuration for ink jet printhead 32 shown in FIG. 2, each of ink ejector arrays 42, 46 and 50 include a plurality of ink ejectors 58, with each ink ejector 58 having a nozzle 59, and having at least one corresponding jetting heater 60.

A swath height 62 of swath 54 corresponds to the distance between the uppermost and lowermost of the nozzles within an array of nozzles of printhead 32. For example, in ink ejector array 50, nozzle 59-1 is the uppermost nozzle and nozzle 59-n is the lowermost nozzle. In the example of FIG. 2, the swath height 62 is the same for each of ink ejector arrays 42, 46 and 50; however, this need not be the case, i.e., it is possible that the swath heights of ink ejector arrays 42, 46 and 50 may be different, either by design or due to manufacturing tolerances.

Controller 22 provides a serial data stream to ink jet printhead 32. The serial data stream may include, for example, data used to provide a sequence of pre-fire and main fire pulses during a printing operation. Individual temperature control may be provided for each jetting heater 60, respectively, for conditioning ink in one or more selected ink ejectors 58 of printhead 32, for example, to account for nozzle discharge variations, ink viscosity, ink vapor point, jetting heater resistance, ink ejector cavity volume, etc., so as to place the ink in the selected ink ejectors 58 in a desired condition prior to executing a main fire pulse to eject the ink. For example, each ink ejector 58 may be preheated to a respective predetermined temperature using a respective non-nucleating pre-fire pulse, on a per ejector basis. Ideally, each non-nucleating heater pulse is of duration that a vapor bubble is not formed in the liquid ink, and accordingly, no drop of ink is ejected from the corresponding ink ejector 58.

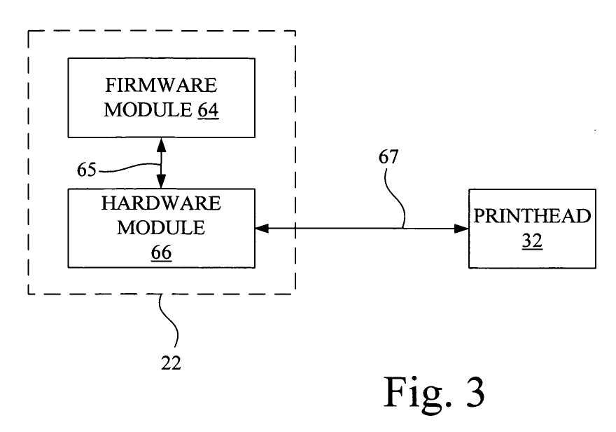

Referring to FIG. 3, there is shown a block diagram representation of a portion of controller 22, including a firmware module 64 and a hardware module 66. Firmware module 64 is communicatively coupled to hardware module 66 via a communication link 65. A serial data channel 67 communicatively couples hardware module 66 to ink jet printhead 32. Hardware module 66 generates the heating data to be applied to ink jet printhead 32 over serial data channel 67, and firmware module 64 controls the timing of operation of hardware module 66, e.g., determines how and when the heating data is communicated via hardware module 66 to ink jet printhead 32. For example, firmware module 64 receives temperature data from ink jet printhead 32, e.g., via temperature sensor 34, processes the temperature data, and in turn controls hardware module 66 in the generation of the heating data, thereby using a closed loop feedback control scheme.

Ink jet printhead 32 is configured to communicate with controller 22 over serial data channel 67, and receives from controller 22 via serial data channel 67 the serial data stream, which includes heating data for heating ink jet printhead 32. For example, the heating data may be a series of pulses that include non-nucleating heating signals to be applied to jetting heaters 60, which in some cases may be accompanied by nucleating signals.

Firmware module 64 and hardware module 66 combine to facilitate pre-printing heating of ink jet printhead 32 so that ink jet printhead 32 has achieved and retains a desired printhead temperature prior to, and up to, the beginning of printing of a print swath, e.g., swath 54. In addition, for example, firmware module 64 and hardware module 66 may continue the heating of ink jet printhead 32 during a printing operation, as needed.

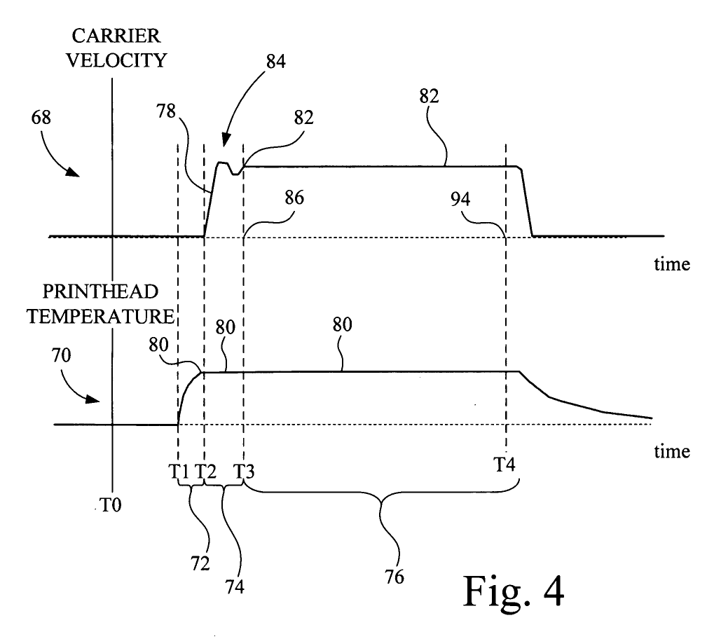

Referring to FIG. 4, there is shown a graph 68 depicting the carrier velocity of printhead carrier 30, carrying printhead 32, in relation to time, correlated with a graph 70 of the printhead temperature of printhead 32 in relation to time. In accordance with one embodiment, the present invention provides three modes of printhead heating, which will be referred to herein as stationary heating 72, pre-swath heating 74, and print heating 76.

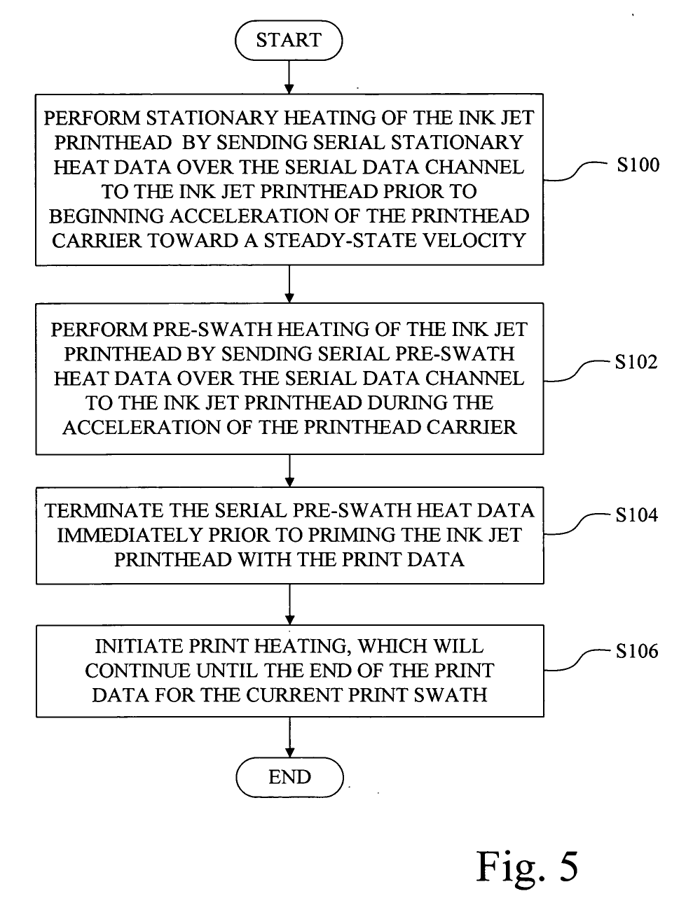

FIG. 5 is a flowchart of a method for performing printhead heating of an ink jet printhead, such as ink jet printhead 32, in accordance with the present invention.

Prior to or during step SI 00, ink jet apparatus 14 may be in an idle state. The idle state may signify, for example, that ink jet apparatus 14 is ready for printing, but that no print job has been initiated. Further, the idle state may be entered at any time that there is a break in the serial data stream being supplied to ink jet printhead 32 on serial data channel 67.

At step S100, stationary heating 72 of ink jet printhead 32 is performed by sending serial stationary heat data over serial data channel 67 to ink jet printhead 32 prior to beginning acceleration of printhead carrier 30 toward a steady-state velocity.

As shown in FIG. 4, at time TO a decision is made to begin a printing operation. At a time T1 following time T0, but prior to the beginning of the acceleration ramp 78 at time T2, stationary heating 72 of ink jet printhead 32 occurs. Sufficient heat is supplied to printhead 32 during stationary heating 72 for the temperature of printhead 32 to reach the desired printhead temperature 80. For example, during stationary heating 72, printhead carrier 30 is stationary, and a serial data stream of non-nucleating heating signals may be supplied by hardware module 66 to printhead 32 for application to the jetting heaters 60 of printhead 32. For example, since no printing data is supplied to printhead 32 during stationary heating 72, the non-nucleating heating signals supplied to printhead 32 may be generated by hardware module 66 using a counter.

At step S102, pre-swath heating 74 of ink jet printhead 32 is performed by sending serial pre-swath heat data over serial data channel 67 to ink jet printhead 32 during the acceleration of the printhead carrier 30 from a stationary position toward a steady-state velocity. In preparation for sending the serial pre-swath data, firmware module 64 configures hardware module 66 to terminate the sending of the serial pre-swath data immediately prior to the priming of printhead 32 with print data.

Referring to FIG. 4, at time T2, printhead carrier 30 carrying ink jet printhead 32 is accelerated at a rate of acceleration corresponding to acceleration ramp 78, and achieves a steady-state printhead velocity 82, after settling 84, by the time ink jet printhead 32 reaches the print start location 86 at time T3.

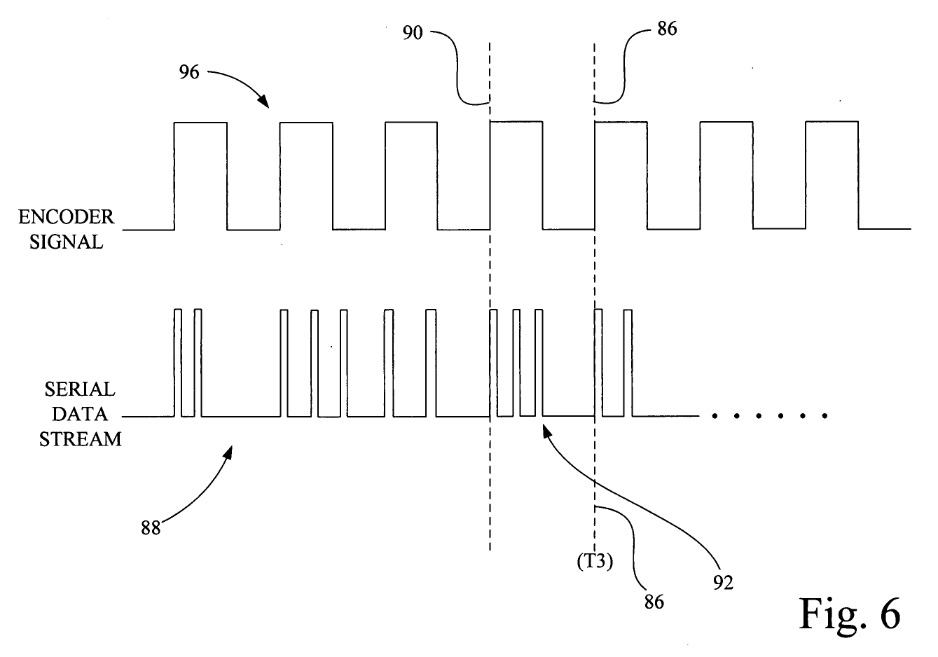

At time T2 stationary heating 72 is terminated by firmware module 64 and pre-swath heating 74 is initiated by firmware module 64. In the prior art, pre-swath heating 74 did not occur, since in the absence of hardware module 66, the firmware needed additional time to prime the printhead, which in turn caused a significant dip in the printhead temperature during printhead carrier acceleration between time T2 and time T3. In accordance with the present invention, referring also to FIGS. 3 and 6, firmware module 64 controls hardware module 66 to execute the mode of pre-swath heating 74 between the mode of stationary heating 72 and the mode of print heating 76 so as to continue to supply non-nucleating heating signals 88 to printhead 32 in the serial data stream over serial data channel 67 during printhead carrier acceleration between time T2 and time T3.

At step S104, hardware module 66 terminates the serial pre-swath heat data immediately prior to priming, e.g., loading, ink jet printhead 32 with print data. For example, ink jet printhead 32 may include a parallel register (not shown) that must be loaded with print data prior to printing at a particular location on the sheet of print media 28. As such, the serial data stream is converted into parallel data and temporarily stored in the parallel register in inkjet printhead 32.

In one embodiment, for example, the serial data stream may be idle momentarily when transitioning from the serial pre-swath heat data to the print data for priming ink jet printhead 32.

As a result of using hardware module 66 to supply non-nucleating heating signals 88 to printhead 32 during pre-swath heating 74, printhead heating may be continued up to the last point in time, identified in FIG. 6 as printhead prime location 90, in which ink jet printhead 32 must be primed with print data 92. In the present example, printhead prime location 90 is one clock cycle of encoder signal 96, i.e., one encoder period of position encoder 37, before print start location 86 at time T3, so as to maintain the printhead temperature of printhead 32 at the desired printhead temperature 80. Each clock cycle of encoder signal 96 corresponds to a distance traveled by printhead carrier 30 as determined by feedback provided by position encoder 37 to controller 22, which in this example is 1/150^{th} of an inch (i.e., 0.006667 inches).

At step S106, print heating 76 is initiated, which will continue until the end of the print data for the current print swath, e.g., swath 54, of the printing operation.

Referring again to FIG. 4, at time T3, the initial priming of ink jet printhead 32 is complete and printing is initiated. During the mode of print heating 76, the printhead temperature may be maintained at the desired printhead temperature 80 using non-nucleating pre-fire pluses in association with the main fire pulses representing print data, which are supplied in the serial data stream on serial data channel 67 to printhead 32 by hardware module 66. Print heating 76 continues to the time T4 corresponding to the end-of-print location 94, and beyond if desired. Accordingly, print heating is continued at least until the end of the print data for the current print swath, e.g., swath 54.

In the embodiment described above, the heating data contained in the serial data stream is directed to jetting heaters 60 in the form of non-nucleating heating signals. However, it is also contemplated that the heating data contained in the serial data stream may be directed to a printhead substrate heater, supplemental to or as an alternative to supplying the heating data contained in the serial data stream to jetting heaters 60.

As an alternative to the method described above, it is contemplated that step S100, i.e., stationary heating, and step S102, i.e., pre-swath heating, may be combined such that hardware module 66 provides a continuous flow of heating data to printhead 32 from the initiating of heating at time T1 (see FIG. 4) to until immediately prior to the priming of printhead 32 with print data, prior to time T3.

The foregoing description of several methods and an embodiment of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. In an ink jet apparatus having a printhead carrier for carrying an ink jet printhead configured to receive a serial data steam over a serial data channel, a method for performing printhead heating of said inkjet printhead, comprising:
performing pre-swath heating of said ink jet printhead by sending serial pre-swath heat data over said serial data channel to said ink jet printhead during an acceleration of said printhead carrier toward a steady-state velocity; and
terminating said serial pre-swath heat data immediately prior to priming said ink jet printhead with print data.

2. The method of claim 1, wherein said terminating said serial pre-swath heat data occurs at one encoder period prior to a print start location.

3. The method of claim 1, wherein said serial pre-swath heat data is generated by a hardware module.

4. The method of claim 3, wherein said hardware module is configured by a firmware module to execute said terminating of said serial pre-swath heat data immediately prior to priming said ink jet printhead with print data.

5. The method of claim 4, said firmware module communicating with said hardware module and said ink jet printhead in providing a closed loop feedback control scheme for maintaining a printhead temperature of said inkjet printhead at a desired temperature.

6. The method of claim 1, further comprising performing stationary heating of said ink jet printhead by sending serial stationary heat data over said serial data channel to said ink jet printhead prior to beginning said acceleration of said printhead carrier toward said steady-state velocity.

7. The method of claim 6, wherein said serial pre-swath heat data and said serial stationary heat data are generated by a hardware module, and comprising controlling a timing of operation of said hardware module via a firmware module.

8. The method of claim 6, wherein said stationary heating and said pre-swath heating are combined to provide a continuous flow of heating data to said inkjet printhead until immediately prior to priming said ink jet printhead with print data.

9. The method of claim 1, further comprising performing print heating of said ink jet printhead subsequent to said priming said ink jet printhead with print data.

10. The method of claim 1, said ink jet printhead including a plurality of jetting heaters, and wherein said serial pre-swath heat data is sent over said serial data channel to at least one jetting heater of said ink jet printhead.

11. The method of claim 1, said inkjet printhead including a plurality of jetting heaters and a substrate heater, and wherein said serial pre-swath heat data is sent over said serial data channel to at least one of a jetting heater and said substrate heater of said ink jet printhead.

12. In an ink jet apparatus having a printhead carrier for carrying an ink jet printhead configured to receive a serial data steam over a serial data channel, a method for performing printhead heating of said ink jet printhead, comprising:
performing stationary heating of said ink jet printhead by sending serial stationary heat data over said serial data channel to said ink jet printhead prior to beginning an acceleration of said printhead carrier toward a steady-state velocity;
performing pre-swath heating of said ink jet printhead by sending serial pre-swath heat data over said serial data channel to said ink jet printhead during said acceleration of said printhead carrier toward said steady-state velocity;
terminating said serial pre-swath heat data immediately prior to priming said ink jet printhead with print data; and
performing print heating of said inkjet printhead during a printing operation, subsequent to said priming said ink jet printhead with print data.

13. The method of claim 12, wherein said terminating said serial pre-swath heat data occurs at one encoder period prior to a print start location.

14. The method of claim 12, wherein said serial pre-swath heat data is generated by a hardware module.

15. The method of claim 14, wherein said hardware module is configured by a firmware module to execute said terminating of said serial pre-swath heat data immediately prior to priming said ink jet printhead with print data.

16. The method of claim 15, said firmware module communicating with said hardware module and said ink jet printhead in providing a closed loop feedback control scheme for maintaining a printhead temperature of said ink jet printhead at a desired temperature.

17. The method of claim 12, wherein said serial pre-swath heat data and said serial stationary heat data are generated by a hardware module, and comprising controlling a timing of operation of said hardware module via a firmware module.

18. The method of claim 12, said ink jet printhead including a plurality of jetting heaters, and wherein said serial pre-swath heat data is sent over said serial data channel to at least one jetting heater of said ink jet printhead.

19. The method of claim 12, wherein said stationary heating and said pre-swath heating are combined to provide a continuous flow of heating data to said ink jet printhead until immediately prior to priming said ink jet printhead with print data.

20. The method of claim 12, wherein said stationary heating and said pre-swath heating are combined to provide a continuous flow of heating data to said ink jet printhead until immediately prior to priming said ink jet printhead with print data.
